(19) United States
(12) Patent Application Publication
(10) Pub. No.: US 2008/0238887 A1
(43) Pub. Date: Oct. 2, 2008

(54) Method and apparatus for programming an interactive stylus button

(75) Inventor: John S. Love, Sioux City, IA (US)

Correspondence Address: GATEWAY, INC.;ATTN: Patent Attorney, 610 GATEWAY DRIVE, MAIL DROP Y-04, N. SIOUX CITY, SD, 57049, US

(73) Assignee: Gateway Inc.

(21) Appl. No.: 11/729,034

(22) Filed: Mar. 28, 2007

(51) Int. Cl. G06F 3/033

(52) U.S. Cl. 345/179

(57) ABSTRACT

A method and apparatus are provided for programming an input device such as a stylus provided with a button and coupled to a computer. Information associated with a position of the stylus may be transferred and a substantially corresponding position of a cursor displayed within a work field of an interface. Activation of the button in a special purpose mode may be detected and a menu with a list of features for programming the stylus may be displayed in the position of the cursor, which remains substantially the same when the menu is displayed.

### FIELD OF THE INVENTION

The present invention generally relates to the field of input technology. In particular the present invention is related to providing a method and apparatus for programming buttons associated with an input device such as an interactive stylus without leaving a field of work.

### BACKGROUND OF THE INVENTION

Input technologies such as mice, trackballs and the like provide a manner for interacting with a graphical user interface (GUI). If a user of the input device desires to activate an object that is displayed on the interface, such as a program icon, the object may be selected and, for example, activated, using the input device. By moving an indicator such as a pointer, which appears as a separate object in the GUI, to a region associated with the object and then performing an activation sequence with the input device such as a mouse click, the operating system may, for example, run the program associated with the object.

As computer technologies have evolved, such as with the advent of the personal digital assistant (PDA), tablet PC, or the like, input technologies have also evolved. To more naturally interface with devices such as the PDA, or the like, the interactive stylus has become a popular choice for users.

Typically, input devices may be programmed by configuring the device during an initial set up procedure or may be configured during operation by interrupting a task in progress and leaving an application field of work and configuration through a toolbar selection, control panel selection, fixed position menu or the like. In stylus devices, such as the DuoSwitch Erasing Ultra Pen manufactured by WACOM Company Ltd. Of Tokyo Japan. The DuoSwitch provides a wide range of button switch functions that may be programmed through operation of a control panel interface. Problems arise however in that in order to program the button features, the stylus must be moved from a work field, the control panel directory must be accessed, the pen icon must be selected, the menu for programming selections must be displayed remote from the work field, the selection must be confirmed, and the setting applied. Only then may the user return to the work field. In some cases, a reboot must be conducted for the new settings to take effect.

Other devices attempt to ease problems associated with software configuration through diverse or inconveniently located menus. For example, in U.S. Patent Application Publication No. 2004/0027392 A1 to Dunn et al., a digitizing pointing device may be configured through external activation buttons that may be linked to programming features. Dunn et al., attempts to address the problem of activating hardware control functions such as volume control that are typically available through a software interface, but, due to the use of a non-mouse pointing device become difficult to configure through normal operation using diverse software interfaces.

Other input devices have the ability to pre-program a button to perform a limited function, such as the gaming grade optical mouse, model MX518, manufactured by Logitech, International of Apples, Switzerland with offices in Fremont Calif. The MX518 mouse has the ability to change mouse resolution through a one click hardware interface that requires no software configuration. Limitations of the MX518 arise in that, since the feature is purely hardware based and thus there is no corresponding software interface for changing the button functionality, no alternate functions may be associated with the resolution changing or “downshift” button.

In still other systems, such as that described in U.S. Patent Application Publication No. 2003/0044069 A1 to Ku, messages from a wireless pen may switch an operational mode of a tablet between, writing, erasing and handwriting recognition modes, subject to proximity of the wireless pen to the tablet as determined by electrical components such as coils and the like. Problems may clearly arise in that due to extensive use of hardware devices such as coils, design factors such as noise, cost, weight, current, and the like will be less than optimum. Ku further fails to provide for configuration and programming.

Consequently, it would be desirable to provide a method and apparatus to allow programming of interactive stylus button functionality without the need for conducting a large number of configuration steps such as activating a control panel, accessing programming selections in a region remote from a work field, and the like.

### SUMMARY OF THE INVENTION

Accordingly, the present invention is directed to a method for programming a stylus, such as an interactive stylus, that is coupled to a computer through a communication channel, which may include a wired channel or may include a wireless channel. Position information associated with a position of the stylus may be transferred and a corresponding position of a cursor displayed within a work field of an interface. The stylus may be equipped with a button and the activation of the button in a special purpose mode may be detected.

A menu may be displayed in response to detecting the activation of the button while in the special purpose mode, which hereinafter will be referred to as a special purpose activation. The menu including a list of features is displayed in the corresponding position of the cursor, which position remains substantially the same when the menu is displayed as when the special purpose activation is detected. Accordingly, when the desired feature is selected and activated, the cursor will appear in substantially the same position so that work may be continued with minimal interruption. It will be appreciated that the menu box includes various selections. The stylus programming selection for programming the operation of the interactive stylus may include various functions that would be useful for stylus operation either in a text manipulation mode or a graphics mode or the like. When the selection of one of the programming features associated with the list is detected, immediate programming of the operation of the interactive stylus may be conducted in response to the detection. Further, the immediately programmed operation of the interactive stylus operates in association with the position within the work field.

In accordance with other exemplary embodiments, a method for programming an interactive stylus communicates position information and other information to a computer over a communication channel. The position information may be associated with a position of the interactive stylus and a corresponding position of a cursor displayed on a display of the computer. The cursor may also be associated with a position within a work field, such as a working area of an application. The interactive stylus has a button capable of being activated in a normal mode and a special purpose mode.

In accordance with an exemplary method or procedure, an activation of the button in the special purpose mode may be detected and a menu box displayed in response to the detecting. The menu box is displayed in the substantially corresponding position of the cursor, which remains in substantially the same as the position within the work field when the menu box is displayed as before the activation of the button. The menu includes a list of programming features or selections. The exemplary method may further include detecting a selection of one of the programming features associated with the list of features. The selection may be invoked or selected. The operation of the interactive stylus may be immediately programmed in response to the selection of the programming feature such that the operation of the interactive stylus in accordance with the immediately programmed feature operates in association with the position within the work field.

In accordance with still other embodiments, a computer may include a display. A processor may be coupled to the display, and an interactive stylus may be coupled to the processor to provide basic operation. The interactive stylus has a button capable of being activated in a special purpose mode. The processor may be configured to process position information associated with the interactive stylus by, for example receiving the position information over a channel. The processor further displays a cursor in a work field associated with a user interface on the display in a position corresponding to the processed position information. The processor may still further detect an activation of the button in the special purpose mode and display a menu box in the substantially corresponding position of the cursor and the position within the work field in response to the activation of the button. The menu box including a list of programming features.

The user interface may include any one of a number of user interfaces or interface mechanisms. The menu box may include a button programming selection for programming an operation of the button, a stylus programming selection for programming an operation of the interactive stylus, and the like. The processor may further be configured to detect a selection of one of the programming features associated with the list and immediately program the operation of the interactive stylus in response to the detecting the selection of the one of the programming features in accordance with the selected feature such that the immediately programmed operation of the interactive stylus operates in association with the position within the work field

It is to be understood that both the forgoing general description and the following detailed description are exemplary and explanatory only and are not restrictive of the invention as claimed. The accompanying drawings, which are incorporated in and constitute a part of the specification, illustrate an embodiment of the invention and together with the general description, serve to explain the principles of the invention.

### BRIEF DESCRIPTION OF THE DRAWINGS

The numerous advantages of the present invention may be better understood by those skilled in the art by reference to the accompanying figures in which:

FIG. 1 is diagram illustrating a computer system employing a stylus that is positioned within a work field consistent with various exemplary embodiments;

FIG. 2A is a diagram illustrating a conventional manner of selecting a toolbar icon with a stylus by leaving a work field;

FIG. 2B is a diagram illustrating a conventional manner of selecting, with a stylus, a feature from a toolbar menu remote from a work field;

FIG. 3 is a diagram illustrating displaying a menu for stylus programming while remaining within a work field consistent with various exemplary embodiments;

FIG. 4 is flow chart illustrating an exemplary procedure for displaying a menu box consistent with various exemplary embodiments;

FIG. 5 is a diagram illustrating an exemplary apparatus for displaying a menu box consistent with various exemplary embodiments; and

FIG. 6 is diagram illustrating hardware and software components consistent with various exemplary embodiments.

### DETAILED DESCRIPTION OF THE INVENTION

The present invention provides a manner such as a procedure and an apparatus to allow programming of a stylus such as an interactive stylus without substantially changing a position of the stylus within, for example, a work field of an interface of an application. Reference will now be made in detail to the presently preferred embodiments of the invention, examples of which are illustrated in the accompanying drawings.

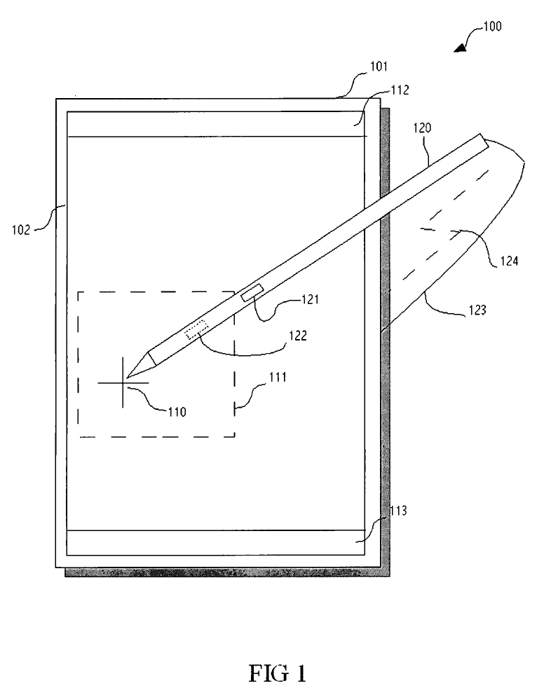

In accordance with various exemplary embodiments, an exemplary scenario 100 is shown in FIG. 1. A computer 101, such as a personal computer (PC), a laptop computer, a tablet PC, a personal digital assistant (PDA) or the like, and may include a display portion 102 and an input device such as a stylus 120, which may be an interactive stylus, pen, or the like as will be appreciated. The stylus 120 may be connected or tethered to computer 101 through a connection such as a wired connection via a cable 123 or a wireless connection via wireless link 124. As will be explained in greater detail, the wired connection via cable 123 may be a simple serial connection, such as a twisted wire pair, coaxial cable, Universal Serial Bus (USB) cable and connector (not shown), or may be a fiber optical connection and the like. Alternatively, the wireless connection 124 may be a radio frequency (RF) link such as, for example, an 802.11 link, Bluetooth link or the like, or may be an infrared link which may also be established using Bluetooth protocols or other protocols as will be appreciated by one of ordinary skill. It will also be appreciated that the display portion 102 may be a liquid crystal display (LCD) or related technology as will be appreciated, a thin film display such as an organic light emitting diode (OLED) display or other display as will be appreciated. The display may further be provided with touch sensitivity or may be passive such that stylus 120 may provide position information. Even in the case where the screen is touch-sensitive, the position information may be generated through the operation of the screen driver and the stylus such that position information is generated and fed to a component of the computer 101 such as the operating system, an application or the like.

In embodiments of the invention, the stylus 120 may be provided with one or more buttons such as button 121 and 122 and may be positioned, for example such that a cursor 110 corresponds to the location of the stylus, such as the stylus tip. It will be appreciated that the cursor 110 may be associated with an interface of a program, application, routine or the like such as a driver program for the interactive stylus, an operating system, a desktop, and an application window. As the position of the stylus 120 is changed and the change is detected and position information is generated, the position of the cursor 110 will correspondingly change. One or more of the buttons 121 and 122 may be activated by clicking, clicking and holding, double clicking or the like. One or more of the buttons 121 and 122 may also be programmed such that various clicking actions correspond to special purpose modes, including activation in accordance with various embodiments. It will also be appreciated that during operation, the stylus 120 may be used within a work field 111 that may represent, for example, a position within a document or a position within a graphic object such as a drawing or the like upon which an operator of the stylus may be working. The display portion 102 may further be provided with, by operation of an application associated with the work field 111 or an operating system or the like, with toolbars such as an upper toolbar 112 and lower toolbar 113, which will be explained in greater detail herein below.

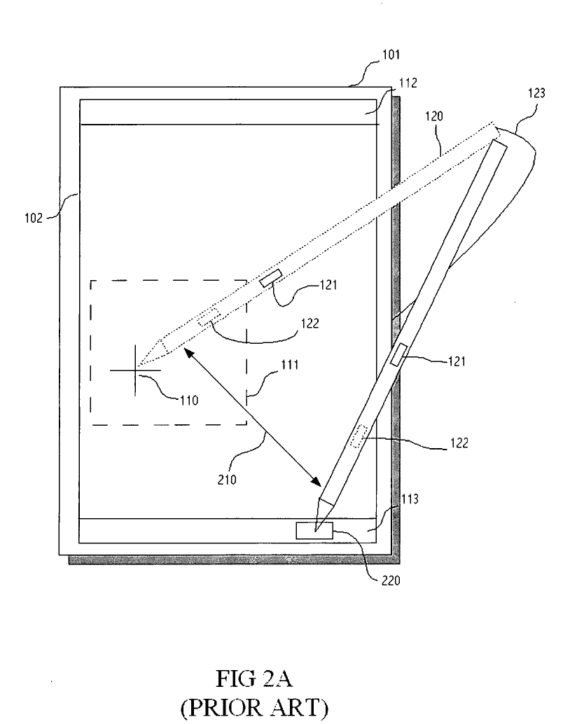

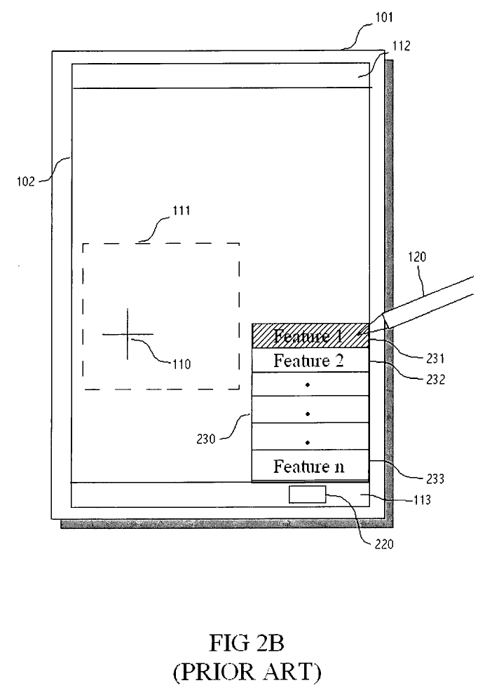

Various disadvantages, for example, as described herein above, are associated with conventional operation and programming of a stylus as shown in connection with FIG. 2A. During operation of the stylus 120, such as during the conducting of work within work field 111, the stylus 120 is located at a position corresponding to the position of the cursor 110. If, during operation within the work field 111, a new operation is desired for the stylus 120, the stylus must be moved a distance 210 away from the work field 111 and the cursor 110 to, for example, activate an icon 220 in lower toolbar 113. It will be appreciated that the icon 220 could also be located in the upper tool bar 112. Alternatively, the user would need to leave the application, go to an operating system window such as a control panel or the like, all of which would be equally disruptive of the operation within the work field 111.

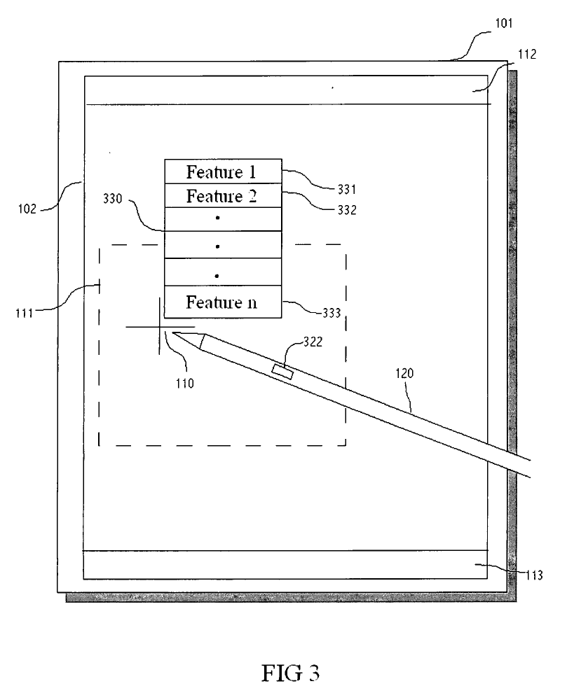

As shown in FIG. 2B, activation of, for example, the icon 220 would result in the display of a menu box 230 containing menu selections for features such as Feature 1 231, Feature 2 232 up to Feature n 233. Additional features may be accessed by selected tabs configured to expand the menu display as will be appreciated. As described above, the disadvantage of the exemplary conventional configuration procedure of FIGS. 2A and 2B, and other procedures, is that the location of the menu box 230 is remote from the work field 111 thus disrupting the flow of work. To address the problems in the art, an exemplary menu box in accordance with various embodiments, is shown in FIG. 3. When a special purpose action is detected, a menu box 330 may be displayed in a substantially corresponding position, or substantially the same position, as the cursor 110. The special purpose action may vary, but in one embodiment includes clicking and holding the button of the stylus, and may further include tapping the stylus on the display, which in some implementations may include or require two taps of the tip of the stylus on the display. In other embodiments, single or multiple clicks of the button and single or multiple taps of the stylus may be used alone or in combination with these or other actions. The selections in the menu box 230 may include, for example, a button programming selection for programming an operation of the button, a stylus programming selection for programming an operation of the interactive stylus, or the like. As a further example, the selections for programming the operation of the interactive stylus may include a highlighter function programming selection, an eraser selection, a lasso programming selection, an insert space programming selection, an insert flag programming selection, and the like. It will be appreciated that the menu box 330 is positioned within easy reach of the stylus 120 from the current position associated with the cursor 110 within the work field 111. Such convenient positioning allows a user to rapidly change functions associated with stylus 120 without disrupting work flow. In some embodiments, the substantially corresponding position at which the menu box 330 is located is at least within the same region of the display portion 102, and the borders of the menu box 330 may illustratively be within less than approximately 20 mm of the cursor 110.

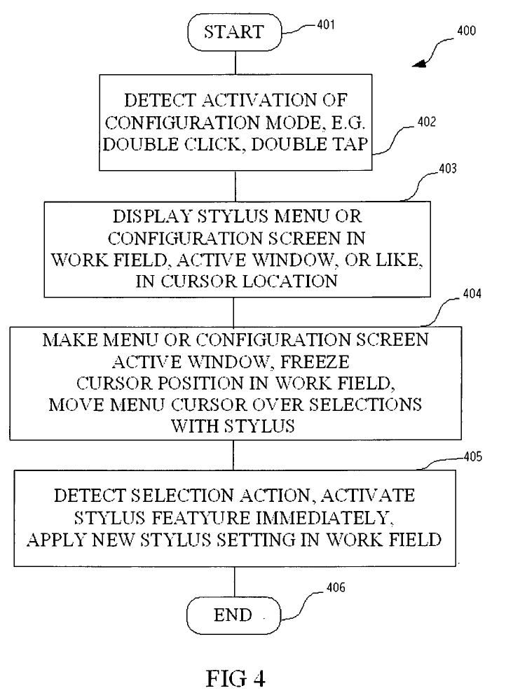

It should be noted that the functionality associated with various exemplary embodiments may best be associated with a procedure, method or the like as in scenario 400 shown in FIG. 4. After start at 401, the activation of the special mode may be detected such as through a software interrupt generated directly by the operating system or through a stylus driver or the like as will be appreciated at 402. When the activation is detected, the menu, configuration screen or the like may be displayed within the work field, for example, in substantially the same location as the cursor at 403. In association with the display of the menu box, the menu box may be assigned, for example, as the active window, such that subsequent movement of the stylus will move a new cursor or highlighter over the various selections while, for example, freezing or otherwise storing the position of the cursor within the work field at 404.

By freezing the position of the cursor within the work field, operation may resume as soon as execution is returned to the associated application. When the desired selection is highlighted, another activation of the button or stylus may be used to select the programming feature and the feature may be immediately activated and applied in the work field at 405. The selection may be made, for example, by use of the stylus and a button click operation or screen tap operation or the like. As will be well understood to one of ordinary skill, the features may include click features associated with various activation modes of the button, erase or highlight features associated with the button or tap mode of the stylus, an object selection mode such as a lasso mode, or the like. Since the modes are well known they are not shown. While the exemplary procedure is indicated as ending at 406, it will be appreciated that the exemplary procedures may be repeated whenever a new function is desired for the stylus and stylus buttons.

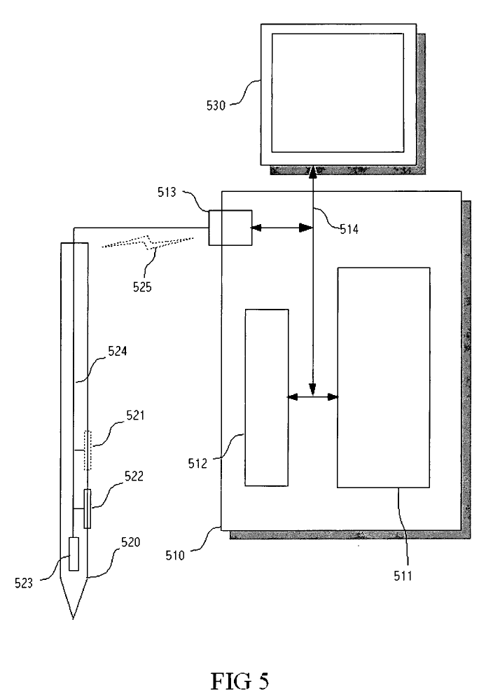

In accordance with other embodiments, such as shown in FIG. 5, an exemplary apparatus may be provided. Accordingly, the computer 510 may be provided with a stylus 520 coupled to the computer 510 through an interface 513, which, as described may be a wired interface associated with a wired link 524 or a wireless interface associated with a wireless link 525. The interface 513 may be an interface for a driver program for the interactive stylus, an operating system, a desktop, or an application window including, for example, a word processing application, a graphics application, or any other application that may use input from the stylus. The computer 510 may include a processor 511, which may be a special or general purpose processor and a compatible memory 512 as will be appreciated. The exemplary apparatus may further be provided with a display 530 that is coupled to the elements of the computer through a connection 514 that may be, for example a bus or the like. The computer 510 and display 530 may further be integrated into a single unit or may be separate units with the stylus 520 capable of operating in connection with the display 530 as described herein, including in a touch screen mode. A stylus 520 may further be provided with one or more buttons such as a button 522 and a button 521 that are coupled to the computer 510 through the wired link 524 or the wireless link 525. In the event that the stylus 530 is of the wireless variety, the wired link 524 may terminate at a wireless transmitter or transceiver (not shown) that would transmit or transmit and receive information to and from an interface 513, which is also configured as a wireless interface as will be appreciated.

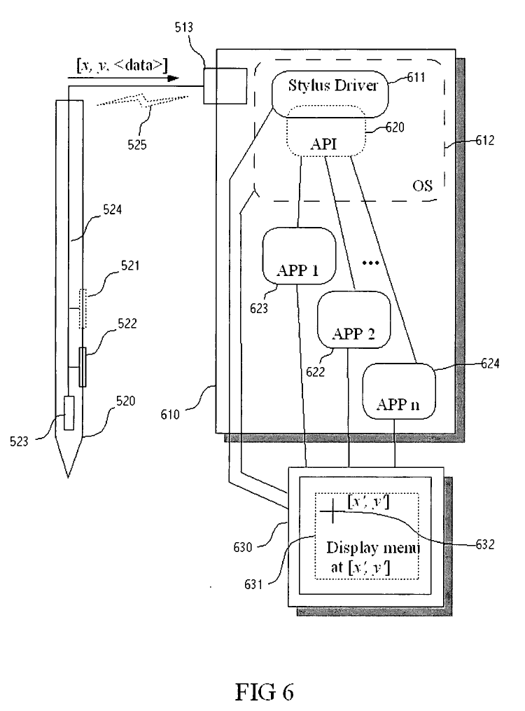

To better appreciate the operation of the exemplary apparatus shown in FIG. 5, entities, such as software entities and hardware entities are shown in FIG. 6. When the stylus 520 moves about in relation to the work field position information such as coordinate information represented as [x, y,] and other information, which may include, for example, button click information represented as <data> are transferred to a computer 610 through an interface 512, which, as noted may be wired or wireless. The position information and other information, e.g. [x, y, <data>] information is transferred to one or more of a stylus driver 611, a method or function provided by way of an API 620, that was used in the development of an exemplary application that uses stylus input such as APP 1 623, APP 2, 622 and APP n 624. The position information [x, y] may be used to update the position [x′, y′] of the cursor 632 on the display 630 within the work field 631, which for illustrative purposes is shown as large in relation to for example the surface of the display 630. It will be appreciated that the size of the work field will be, for example, an area immediately surrounding the cursor 631.

It is believed that the method and apparatus of the present invention and many of its attendant advantages will be understood by the forgoing description. It is also believed that it will be apparent that various changes may be made in the form, construction and arrangement of the components thereof without departing from the scope and spirit of the invention or without sacrificing all of its material advantages. The form herein before described being merely an explanatory embodiment thereof. It is the intention of the following claims to encompass and include such changes.

What is claimed is:

1. A method for programming a stylus coupled to a computer through a communication channel that transfers position information associated with a position of the stylus and a substantially corresponding position of a cursor displayed within a work field of an interface, the stylus having a button, the method comprising:
detecting an activation of the button in a special purpose mode; and
displaying a menu in response to the detecting the activation of the button in the substantially corresponding position of the cursor, the menu including a list of features,
wherein the substantially corresponding position of the cursor remains substantially the same when the menu is displayed.

2. The method for programming according to claim 1, wherein the activation of the button in the special purpose mode includes a clicking and holding the button of the stylus.

3. The method for programming according to claim 2, wherein the activation of the button in the special purpose mode includes tapping the stylus on a display associated with the computer.

4. The method for programming according to claim 3, wherein the wireless channel includes one of a radio frequency channel, an optical channel and an infrared channel.

5. The method for programming according to claim 3, wherein the wired channel includes one of a wire-pair serial communication channel, a Universal Serial Bus (USB) channel and a coaxial communication channel.

6. The method for programming according to claim 1, wherein the interface is associated with one or more of a driver program for the stylus, an operating system, a desktop, and an application window.

7. The method for programming according to claim 1, wherein the menu box includes one of a button programming selection for programming an operation of the button and a stylus programming selection for programming an operation of the stylus.

8. The method for programming according to claim 7, wherein the menu box stylus programming selection for programming the operation of the stylus further includes one of a highlighter function programming selection, an eraser programming selection, a lasso programming selection, a insert space programming selection, an insert flag programming selection.

9. The method for programming according to claim 1, further comprising:
detecting a selection of one of the programming features associated with the list of features, and
immediately programming the operation of the stylus in accordance with the selected programming feature in response to the detecting the selection of the one of the programming features such that the immediately programmed operation of the stylus operates in association with the position within the work field.

10. A method for programming an interactive stylus that communicates position information and other information to a computer over a communication channel, the position information associated with a position of the interactive stylus and a substantially corresponding position of a cursor displayed on a display of the computer, the cursor associated with an interface and a position within a work field, the interactive stylus having a button capable of being activated in one of a normal mode and a special purpose mode, the method comprising:
detecting an activation of the button in the special purpose mode; and
displaying a menu box in response to the detecting the activation of the button in the substantially corresponding position of the cursor, the menu box including a list of programming features,
wherein the substantially corresponding position of the cursor remains substantially the same as the position within the work field when the menu box is displayed.

11. The method for programming according to claim 10, wherein the activation of the button in the special purpose mode includes a clicking and holding the button of the stylus.

12. The method for programming according to claim 11, wherein the activation of the button in the special purpose mode includes tapping the stylus on the display associated with the computer.

13. The method for programming according to claim 10, wherein the menu box includes one of a button programming selection for programming an operation of the button and a stylus programming selection for programming an operation of the interactive stylus.

14. The method for programming according to claim 13, wherein the menu box stylus programming selection for programming the operation of the interactive stylus further includes one of a highlighter function programming selection, an eraser programming selection, a lasso programming selection, a insert space programming selection, an insert flag programming selection.

15. The method for programming according to claim 10, further comprising:
detecting a selection of one of the programming features associated with the list of programming features, and
immediately programming the operation of the interactive stylus in response to the selection of the one of the programming features such that the immediately programmed operation of the interactive stylus operates in association with selected one of the programming features in the position within the work field.

16. A computer comprising:
a display;
a processor coupled to the display; and
an interactive stylus coupled to the processor, the interactive stylus having a button capable of being activated in a special purpose mode, the processor configured to:
process position information associated with the interactive stylus;
display a cursor in a work field associated with a user interface on the display in a position substantially corresponding to the processed position information;
detect an activation of the button in the special purpose mode; and
display a menu box in the substantially corresponding position of the cursor and the position within the work field in response to the detecting the activation of the button, the menu box including a list of programming features.

17. The computer according to claim 16, wherein the processor in detecting the activation of the button in the special purpose mode is further configured to detect a click and hold operation of the button.

18. The computer according to claim 17, wherein the processor in detecting the activation of the button in the special purpose mode is further configured to detect a tapping of the stylus on the display.

19. The computer according to claim 16, wherein the user interface includes one or more of a driver program for the interactive stylus, an operating system, a desktop, and an application window.

20. The computer according to claim 16, wherein the menu box includes one of a button programming selection for programming an operation of the button and a stylus programming selection for programming an operation of the interactive stylus.

21. The computer according to claim 20, wherein the menu box stylus programming selection for programming the operation of the interactive stylus further includes one of a highlighter function programming selection, an eraser programming selection, a lasso programming selection, a insert space programming selection, an insert flag programming selection.

22. The computer according to claim 16, wherein the processor is further configured to:
detect a selection of one of the programming features associated with the list of programming features, and
immediately program the operation of the interactive stylus in response to the selection of the one of the programming features such that the immediately programmed operation of the interactive stylus operates in association with the selected one of the programming features in the position within the work field.
